(19) United States
(12) Patent Application Publication
(10) Pub. No.: US 2021/0276347 A1
(43) Pub. Date: Sep. 9, 2021

(54) MEDIA CUTTER ASSEMBLY AND PRINTER

(71) Applicant: HEWLETT-PACKARD DEVELOPMENT COMPANY, L.P., Spring, TX (US)

(72) Inventor: Jaime Blanco Gabella, Sant Cugat del Valles (ES)

(21) Appl. No.: 16/603,825

(22) PCT Filed: Jan. 30, 2018
(86) PCT No.: PCT/US2018/015882

§ 371 Date: Oct. 8, 2019

(51) Int. Cl. B41J 11/70; B26D 1/02; B26D 1/30; B26D 5/08

(52) U.S. Cl. CPC B41J 11/706; B26D 1/025; B26D 2001/0066; B26D 5/08; B26D 1/305

(57) ABSTRACT

A cutter assembly for a printer comprises: an active cutter module to be arranged at a printer carriage, the active cutter module including a movable cutting blade and a transmission, a passive cutter module to be arranged opposite the active cutter module, with a print media path located between the active cutter module and the passive cutter module; and a drive component to be engaged and disengaged with the transmission.

### BACKGROUND

Some printers include a cutter assembly which can cut a print medium before or after a printing operation. The cutter assembly may include a cutting blade supported on a carriage to move across a print zone. By movement of the carriage across the print zone and/or movement of the print medium along a media advance path through the print zone, the cutting blade may cut in one or two linear directions, such as the X and Y directions.

### BRIEF DESCRIPTION OF DRAWINGS

The following description references the drawings, wherein

FIG. 1 is a schematic overview of part of a printer including a cutter assembly, according to an example;

FIG. 2 is a block diagram schematically illustrating a cutter assembly according to an example, in a front view thereof;

FIG. 3 is a block diagram schematically illustrating the cutter assembly of FIG. 1, showing further details according to an example;

FIG. 4 is a block diagram schematically illustrating an active cutter module of the cutter assembly of FIG. 2, showing further details according to an example;

FIG. 5 is a block diagram schematically illustrating a passive cutter module of the cutter assembly of FIG. 2, showing further details according to an example;

FIG. 6 is a block diagram schematically illustrating the passive cutter module of FIG. 5, according to an example, in a side view thereof;

FIG. 7 is a block diagram schematically illustrating a cutter assembly according to another example, in a front view thereof;

FIG. 8 is a block diagram schematically illustrating the active cutter module of the cutter assembly of FIG. 7, according to an example, in a side view thereof;

FIG. 9 is a block diagram schematically illustrating a cutter assembly according to another example, in a front view thereof;

FIG. 10 is a diagram illustrating the cutter assembly of FIG. 10, showing further details according to an example;

FIG. 11 is a diagram illustrating the active cutter module of the cutter assembly of FIG. 10, in a front view thereof;

FIG. 12A schematically illustrates a media advance system according to an example, in a side view thereof;

FIG. 12B schematically illustrates the media advance system of FIG. 12A, in a top view thereof;

FIG. 13 is a diagram illustrating a cutter assembly, according to another example, in a perspective view thereof;

FIG. 14 is a diagram illustrating the active cutter module of the cutter assembly of FIG. 13, in a side view thereof;

FIG. 15A schematically shows a top view of a medium including cut lines according to various examples;

FIG. 15B schematically shows a top view of a medium including cut lines according to various other examples;

FIG. 16 shows a flow diagram of a cutting sequence according to an example;

FIG. 17 shows a flow diagram of a cutting sequence according to another example; and

FIG. 18 shows a flow diagram of a cutting sequence according to another example.

### DETAILED DESCRIPTION

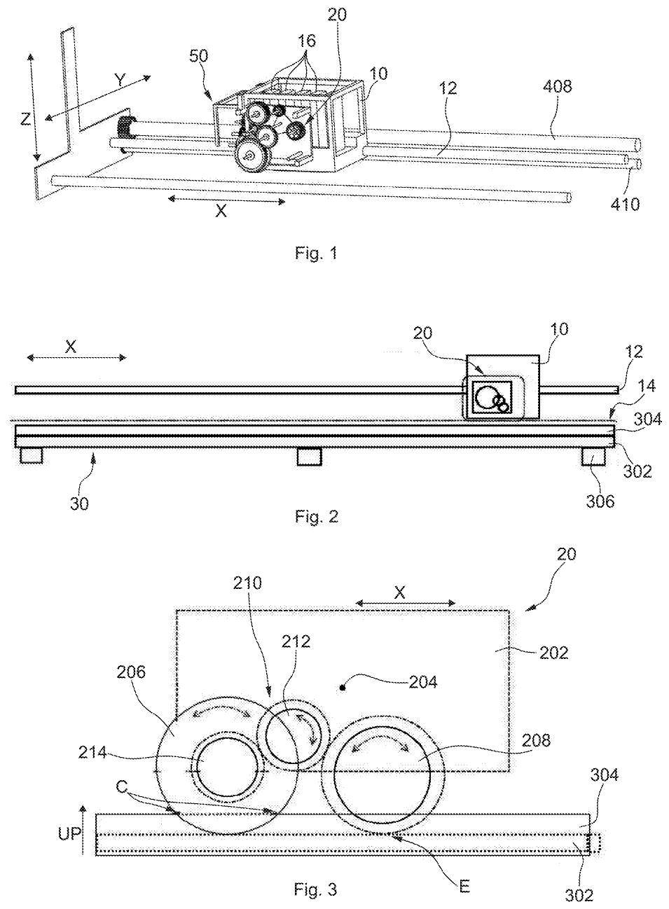

FIGS. 1 and 2 provide a schematic overview of an environment in which a cutter assembly according to an example may be provided. In this example, the cutter assembly is provided in a printer, such as a large format printer which prints on a continuous web of a print medium, such as a continuous web of paper, carton, textile or foil, for example. The print medium also may be provided as single sheets that are fed from an input tray or a drawer, or a roll of paper, for example. The printer may be an inkjet printer or another type of scanning printer which comprises a printer carriage 10 which carries one or several print heads 16. The printer carriage may scan across a print zone in a scanning direction and the print head(s) may deposit a printing fluid on the print medium, when the print medium is transported through the print zone in a print media advance direction. For example, one replaceable inkjet print head or four, MCYK, ink inkjet print heads may be provided in the carriage. A printing fluid may be dispensed from the print heads which may be any fluid that can be dispensed by an inkjet-type printer or other inkjet-type dispenser and may include inks, varnishes, and/or post or pre-treatment agents, for example.

A print zone may be defined as the entire area or part of the area which can be traversed by the carriage. The scanning direction of the carriage also may be designated as X direction, the print media advance direction also may be designated as Y direction, and the direction of gravity also may be designated as Z direction. In the context of this application, a front view of the printer and cutter assembly corresponds to a view in the X-Z plane, and a side view corresponds to a view in the Y-Z plane. A top view corresponds to a view in the X-Y plane.

FIGS. 1 and 2 schematically show a printer carriage 10 which can move along a slide bar 12 in the scanning direction or X direction, illustrated by arrow X. Attached to the printer carriage 10 is an active cutter module 20 of an X cutter assembly and an active cutter module 50 of a Y cutter assembly, described in further detail below. The printer carriage 10 and the active cutter modules 20, 50 are located above a print zone, schematically illustrated by line 14, through which a print medium is to be transported and where a print fluid is to be deposited on the print medium. In the example of FIG. 2, a passive cutter module 30 of the X cutter assembly is located below the print zone 14, described in further detail below. The printer may further comprise a platen (not shown) to support the print medium in the print zone, and a print medium advance system to transport the print medium through the print zone in the media advance direction Y. The print media advance system may comprise media transport rollers (schematically shown at 408, 410 in FIG. 1). The X cutter assembly of FIG. 2 is designed to cut in the scanning direction X.

In the context of this application, the active cutter module 20 is designated “active” because is includes a carriage-driven cutter and hence actively cuts the medium by means of the carriage, and the passive cutter module 30 is designated “passive” because it is not carriage-activated.

Further details of the active cutter module 20 and the passive cutter module 30 of the X cutter assembly, according to an example, are schematically illustrated in FIG. 3. In this example, the active cutter module 20 comprises a pivotable support frame 202 having a pivot point 204 at which the active cutter module 20 is pivotably coupled to the printer carriage, a cutter, e.g., rotary cutting blade 206, and a transmission 210 including a drive gear 208. In this example, the active cutter module 20 is located at a side of the carriage 10 which extends parallel to the scanning direction X and also the rotary cutting blade 206 extends in a plane parallel to the scanning direction X. The carriage side to which the active cutter module 20 is attached may be the front side or the backside of the carriage, in the media advance direction Y, depending on whether the cutter assembly should be located upstream or downstream of the print zone. In this specific example, the transmission 210 comprises the drive gear 208 and an intermediate gear 212, between the drive gear 208 and a gear 214 of the rotary cutting blade 206, but additional intermediate gears or other transmission elements may be provided. The gears may be toothed gears or friction gears or may be replaced or supplemented by other transmission elements. The gears may be plastic or metal parts. The drive gear 208, the intermediate gear 212 and the rotary cutting blade 206, including its gear 214, are rotatably coupled to the support frame 202. Furthermore, other types of cutters may be used instead or in addition to the rotary cutting blade 206, for example, linear or static cutting blades. Rotary cutting blades may have, amongst others, a feature of having controllable rotational speeds that can be provided by a controller depending on the print medium.

The passive cutter module 30 of this example comprises a drive component including a linear rack 302, and a linear cutting blade 304 which both extend parallel to each other and in the carriage scanning direction X and which, in this example, are attached to one another. The linear rack 302 may be a toothed rack or may have a friction surface, for example. The linear rack 302 may be a rigid plastic or metal part. The passive cutter module 30 can be raised and lowered in the Z direction to engage and disengage the linear rack 302 with/from the drive gear 208 and to engage and disengage the rotary cutting blade 206 and the linear cutting blade 304. Instead of a cutting blade, the passive cutter module 30 may comprise a cutting surface which provides a counter surface to the rotary cutting blade 206.

When the drive gear 208 is engaged with the linear rack 302 and when the carriage 10 and hence the active cutter module 20 moves in the carriage scanning direction X, the drive gear 208 revolves on the linear rack 203 and rotation of the drive gear 208 is transmitted to the rotary cutting blade 206 via the intermediate gear 212 to cut a medium between the rotary cutting blade 206 and the linear cutting blade 304. The point of engagement between the drive gear 208 and the linear rack 302 is illustrated by arrow E, at the cutting zone between the rotary cutting blade 206 and the linear cutting blade 304 is illustrated by arrows C.

FIG. 3 illustrates the cutter assembly in the activated or cutting position which, in this example, is a position where the passive cutter module 30, including the linear rack 302, is raised (UP) in the Z direction. The passive cutter module 30 may comprise an electromotive or electromagnetic actuator or several actuators 306 (see FIGS. 2 and 5) to raise and lower the passive cutter module 30 and hence to engage and disengage the drive roller 208 and the linear rack 302 as well as the rotary cutting blade 206 and the linear cutting blade 304. Raising of the passive cutter module 30 also may cause the active cutter module 22 pivot around pivot point 204 from a standby position into a cutting position, as further explained below. Alternatively, the active cutter module 20 may be transferred to the cutting position by another type of mechanism, such as an electromotive or electromagnetic actuator associated with the active cutter module 20.

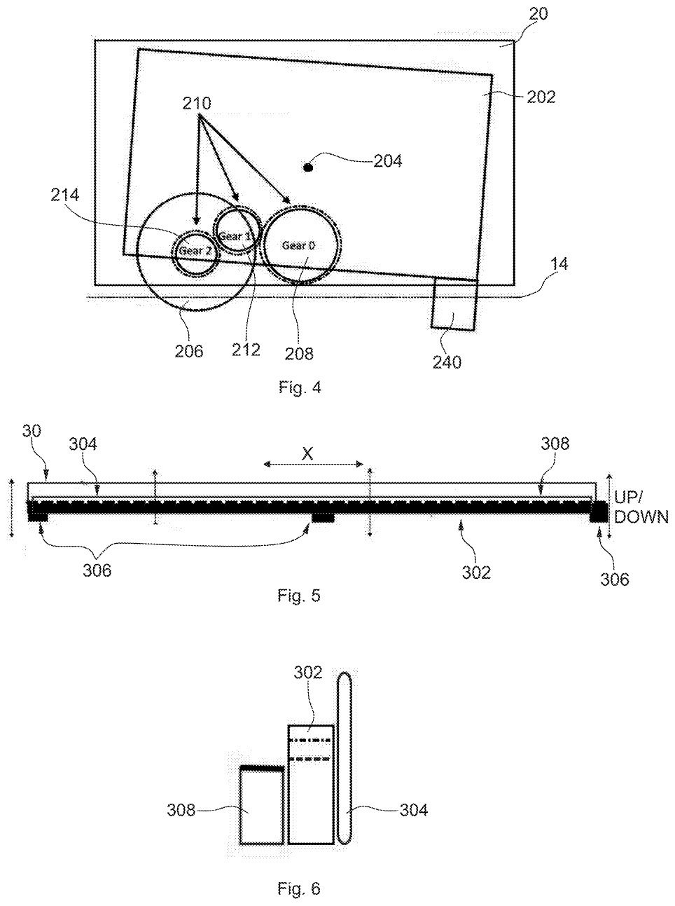

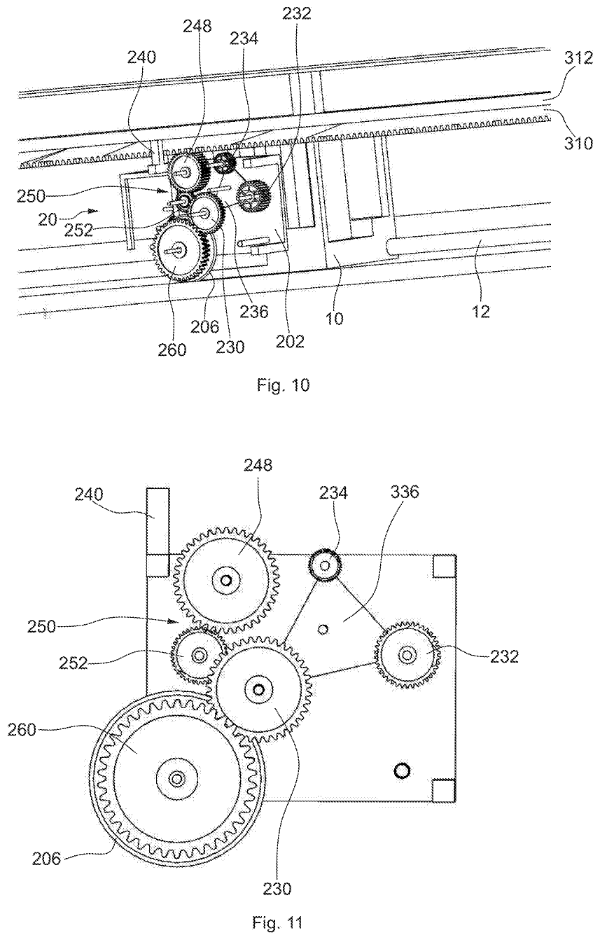

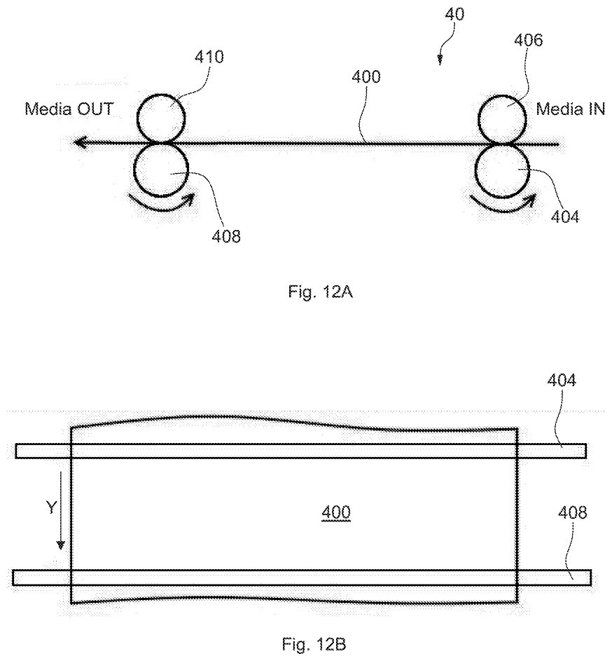

FIG. 4 shows a block diagram schematically illustrating the active cutter 20 module of the cutter assembly of FIG. 1, according to an example. In this example, the transmission 210 includes a gear train of three gears 208, 212, 214 which may provide a transmission ratio of one, above one or below one. In the example of FIGS. 3 and 4, the active cutter module comprises a fixed ratio transmission. In an alternative, a transmission having a variable transmission ratio can be provided, an example of which is described below with respect to FIGS. 10 and 11. FIG. 4 further illustrates the pivotable support frame 202 having pivot point 204 at which the active cutter module 20 is pivotably coupled to the printer carriage 10. A pusher component 214 is coupled to the pivotable support frame 202 to be engaged with a directing component that may be associated with the linear rack 302.

In one example, illustrated in FIG. 5, the directing component comprises a sliding surface 308 extending parallel to the linear rack, as explained below. When the linear rack 302 is moved up to be engaged with the drive gear 208, the pusher component 240 is engaged with the sliding surface 308 to pivot the active cutter module 20 from a standby position (shown in FIG. 4) to the cutting position (shown in FIG. 3). In the standby position, the rotary cutting blade 206 is raised above a plane at which the medium is transported between the active cutter module 20 and the passive cutter module 30. In the cutting position, the rotary cutting blade 206 is lowered to penetrate the plane at which the medium is transported and to engage with the linear cutting blade 304 at the cutting zone C-C, illustrated in FIG. 3. In the cutting position, the drive gear 208 also engages with the linear rack 302.

In the example of FIG. 4, a cutting operation proceeds from right to left, in the drawing plane, with the pusher component 240 located downstream of the rotary cutting blade 206. Also the transmission 210 is a generally located downstream of the rotary cutting blade 206 so that the drive gear 208 rotates behind the rotary cutting blade 206 rather than at the front of it, in the direction of movement. Accordingly, the medium does not interfere with the drive and the rotary cutting blade “attacks” the medium before it can come into contact with the drive mechanism. Once cut, the two split parts of the medium can be guided away from the drive mechanism.

FIG. 5 shows a block diagram schematically illustrating the passive cutter module 30 of the cutter assembly of FIG. 2, according to an example. FIG. 5 shows the linear rack 302 and linear blade 304 which are attached to each other and extend parallel to each other in the scanning direction X, as explained below. The passive cutter module 30 may comprise an electromotive or electromagnetic or another type of actuator or several actuators 306 to raise and lower the passive cutter module 30, UP/DOWN, and hence to engage and disengage the drive roller 208 and the linear rack 302 as well as the rotary cutting bade 206 and the linear cutting blade 304. FIG. 5 further schematically illustrates a directing component 308 providing a sliding surface which may engage with the pusher component 240 of the active cutter module 20 when the passive cutter module 30 is raised to transfer the active cutter module 22 to the cutting position. In this example, the directing component 308 may be a bar attached to and extending parallel to the linear rack 302, providing the sliding surface.

FIG. 6 schematically illustrates the passive cutter module of FIG. 5, in a side view thereof. FIGS. 5 and 6 show simplified views, illustrating the linear rack 302, the linear cutting blade 306 and the directing component 308 of the passive cutter module, wherein further details have been omitted. FIGS. 5 and 6 show how the linear rack 302, the linear cutting blade 304 and the directing component 308 may be arranged relative to each other, all extending parallel in the scanning direction X and being rigidly fixed to each other.

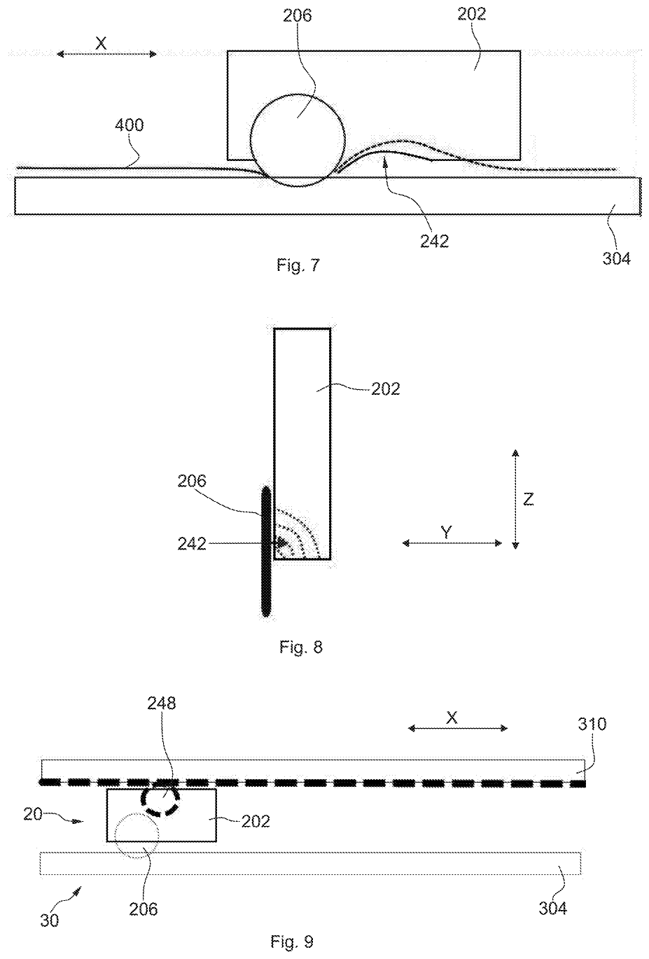

FIG. 7 is a block diagram schematically illustrating a cutter assembly according to another example, in a front view thereof; and FIG. 8 schematically illustrates the active cutter module of the cutter assembly of FIG. 7, according to an example, in a side view thereof. FIG. 7 provides a simplified view, showing the support frame 202 and the rotary cutting blade 206 of the active cutter module and the linear cutting blade 304 of the passive cutter module, wherein further details have been omitted. With regard to further details of the active cutter module and the passive cutter module, reference is made to the description of the examples shown in FIG. 1 to 6, above. Any of these details and combinations thereof may be provided also in the cutter assembly of FIGS. 7 and 8.

FIG. 7 shows the cutter assembly in a cutting position, with a medium 400 to be cut extending between the active and passive cutter modules. In the example of FIG. 7, the support frame 202 features a media deflector 242. The media deflector 242 may be a three-dimensionally shaped surface provided at the support frame 202, extending in the Z and Y directions to bend and deflect the medium as the cutter assembly moves along the X direction so that the two cut parts of the medium will be deflected out of the way of the engaged rack 302 and drive gear 208. One of the cut parts of the medium is illustrated by dashed line 402 in FIG. 7. FIG. 8 schematically shows a side view of the support frame 202 and the rotary cutting blade 206 attached thereto, wherein the three-dimensional shape of the media deflector 242 is illustrated by dotted lines.

FIG. 9 provides schematic overviews of a cutter assembly according to another example, in a front view thereof. Also in this example, the cutter assembly may be provided in a printer. Similar to the previous examples, the cutter assembly includes an active cutter module 20 and a passive cutter module 30 wherein FIG. 9 illustrates the support frame 202 and the rotary cutting blade 206 of the active cutter module 20 and the linear cutting blade 304 of the passive cutter module 30. Different from the previous examples, the drive component is separate from the passive cutter module 30 by providing a linear rack 310 above the active cutter module 20. Accordingly, a drive gear 248 of the active cutter module 20 may be arranged at an upper side of the support frame 202, to be engaged with and disengaged from the linear rack 310. A transmission may be provided between the drive gear 248 and the rotary cutting blade 206, not illustrated in FIG. 9. Arranging the rack/drive gear mechanism above the active cutter module 20 allows avoiding interference between the gears and the cut medium. Accordingly, a deflector or other means for guiding the cut medium parts away from the gears can be omitted and cutting of more rigid media, which re not easily deflected, without interference with the rack and gears is facilitated.

As in the previous examples, the active cutter module 20 is located at a side of the carriage 10 which extends parallel to the scanning direction X and also the rotary cutting blade 206 and the linear cutting blade 304 extend parallel to the scanning direction X. The linear cutting blade of the passive cutter module (not shown) may be provided at a fixed position below the active cutter module 20 or, alternatively may be provided with its own actuator to raise and lower the cutting blade between a lowered standby position and a raised cutting position. Instead of a linear cutting blade, the passive cutter module may feature a cutting surface which provides a counter surface to the rotary cutting blade 206 of the active cutter module 20. In another example, the passive cutter module may comprise a rotary cutting blade, a linear cutting blade or a counter surface which is arranged in the passive cutter module below the print zone, with a contact-free coupling device, e.g. comprising controllable magnets, in the active cutter module and the passive cutter module, to engage the rotary cutting blade of the active and cutting blade or cutting surface of the passive cutter module wherein, when engaged, the passive cutter module follows movement of the active cutter module and, when disengaged, the passive cutter module remains at a given position irrespective of a movement of the active cutter module.

The drive component may have a design similar to the previously described examples, including the linear rack 310, a directing component 312 having a sliding surface, and actuators for raising and lowering the drive component. The active cutter module 20 comprises a respective pusher component 240 which interacts with the sliding surface of the directing component 312 to pivot the active cutter module 20 and hence the cutting blade 260 into a cutting position. In this regard, reference is made to the description of FIG. 2 to 5, for example. However, as mentioned, the drive component including the linear rack 310 is separate from the linear blade 304 of the passive cutter module 30. As in the other examples, the actuators may be electromotive or electromagnetic actuators, for example. The linear cutting blade 304 may be fixed in its position. In an alternative, the linear cutting blade 304 may be associated with an actuator to raise and lower the linear cutting blade 304. The support frame 202 of the active cutting module 20 may be pivotable around pivot point and, as in the previous examples, may include a pusher component 240 which engages with the sliding surface of the directing component 312 to pivot the active cutting module between a standby position and a cutting position, with the cutting position illustrated in FIG. 9. In this regard, reference is made to the description of FIG. 2 to 5.

As in the previous examples, the active cutter module 20 comprises a transmission 250 between the drive gear 248 and the cutting blade 206, an example of which is illustrated FIGS. 10 and 11. The transmission 250 may have a fixed or variable transmission ratio, wherein FIGS. 10 and 11 shown example of a variable transmission ratio. In this example where the linear rack 310 is above the active cutter module 20 instead of below, and opposite to the rotary cutting blade 206, the position of the pusher component 240 relative to the drive mechanism can be any, i.e. upstream or downstream of the cutting direction, as the medium is not guided between the linear rack 310 and the drive gear 248.

FIGS. 10 and 11 schematically show an example of the cutter assembly of FIG. 9, in further detail. FIG. 10 illustrates the carriage 10 and the slide bar 12, the carriage 10 carrying the active cutter module 20. As in the previous example, the active cutter module 20 comprises the rotary cutting blade 206 and drive gear 248 attached to the support frame 202. The linear rack 310 is attached to the printer frame above drive gear 248. To begin with the interaction between the drive gear 248 and the linear rack 310, the linear rack 310 is illustrated as a toothed rack, and the drive gear 248 is illustrated as a toothed pinion gear, meshing with the teeth of the linear rack 302. When the drive gear 248 revolves on the linear rack 302, rotation of the drive gear 248 is transmitted to the transmission 250 of the active cutter module 20.

In the example of FIGS. 10 and 11, the transmission 250 comprises a gear train, including two invariable input gears 248, 252, one of which is the drive gear, and one invariable output gear 260 which is coaxially attached to a side of the rotary cutting blade 206. The input gear 252 and output gear 260 are coupled via one of a number of variable intermediate gears 230, 232, 234 which may be selected to vary a transmission ratio of the transmission 250. FIGS. 10 and 11 schematically show a selector 336 including a pivotable plate supporting the variable intermediate gears 230, 232, 234 to pivot a selected one of the variable intermediate gears 230, 232, 234 into engagement with the invariable input gear 252 and the invariable output gear 260 to complete the gear train. The gears may be toothed gears or friction gears or may be replaced or supplemented by other transmission elements.

The number and size of gears may be designed to achieve a desired transmission ratio wherein the transmission ratio may be fixed or selectable, by omitting or providing the illustrated variable intermediate gears. A transmission ratio of one (1) drives the rotary cutting blade 206 at a rotary speed corresponding to the velocity at which the carriage 10 travels along the slide rail 12. A higher transmission ratio drives the rotary cutting blade 206 at higher rotary speed and a lower transmission ratio drives the rotary cutting blade 206 at a lower rotary speed. The rotary speed may be selected, for example, in response to the type of medium to be cut, such as the thickness and/or rigidity of the medium. For example, for a thicker and/or harder medium a higher cutting speed may be selected then for thinner and/or softer medium.

FIGS. 12 A and 12 B schematically show a media advance system 40 of a printer according to an example, in a side view and a top view thereof, for illustrating a cutter assembly according to a further example, the cutter assembly designed for cutting in the media advance direction Y. The media advance system 40 comprises media transport rollers, including a set of input rollers 404, 406 and a set of output rollers 408, 410. A medium 400 is pinched between the set of input rollers 404, 406 and the set of output rollers 408, 410 to be transported from a media input side, media IN, to a media output side, media OUT. Input rollers 404, 406 feed the medium 400 to a printing area, and output rollers 408, 410 pull the medium 400 out from the printing area, wherein the printing area may be located anywhere between the two sets of rollers. Respective ones of the two sets of rollers may be driven rollers; e.g. input roller 404 and output roller 408 may be driven rollers. Output roller 408 may be driven at a slightly higher speed than input roller 404 to create tension in the medium 400. The media advance direction is illustrated by arrow Y in FIG. 12B.

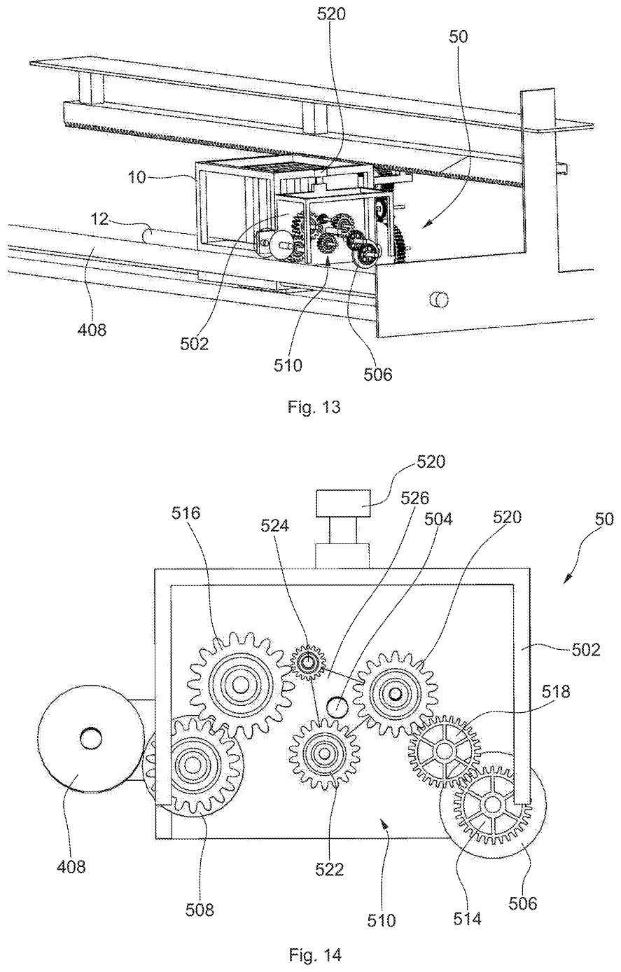

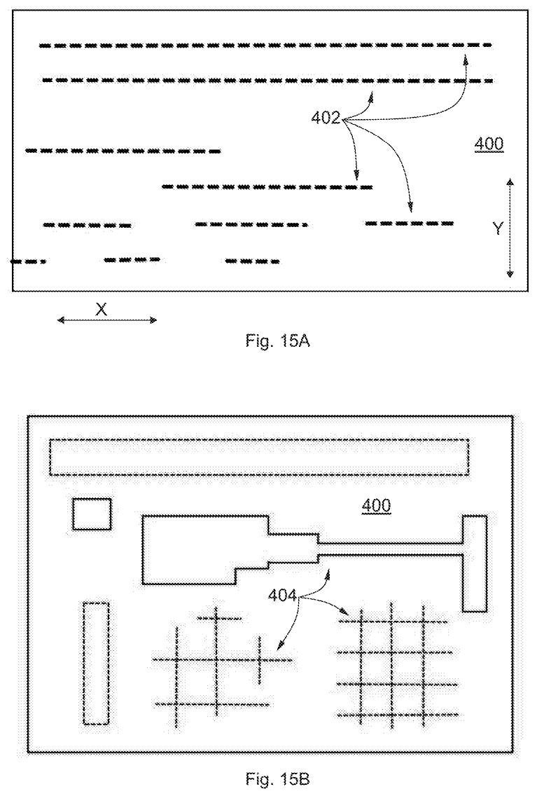

In the example illustrated in FIGS. 13 and 14, an active cutter module 50 of a Y cutter assembly is shown in a perspective view and in a side view thereof, i.e. in a Y-Z plane, corresponding to the view of FIG. 12A. The active cutter module 50 may be arranged at the side face of the carriage 10 so that the rotary cutting blade 506 of the active cutter module 50 extends in the media advance direction Y. Similar to the previous examples, the active cutter module 50 comprises a pivotable support frame 502 having a pivot point 504 at which the active cutter module 50 is pivotably coupled to the printer carriage, the rotary cutting blade 506, and a transmission 510 including a drive roller 508 and intermediate gears. The carriage side to which the active cutter module 50 is attached may be the left-hand side or the right-hand side of the carriage, depending on whether the cutter assembly should be located upstream or downstream of the carriage movement from left to right or from right to left. In this specific example, the transmission 510 comprises the drive roller 508, intermediate gears, and a gear 514 coaxially attached to the rotary cutting blade 506. Between the drive roller 508 and the gear 514, a gear train having a variable transmission ratio is provided, the gear train including one additional invariable input gear 516 and one additional invariable output gear 518, with three variable intermediate gears 520, 522, 524 which can be selected to complete the gear train wherein the schematic drawing of FIGS. 13 and 14 is not a fully realistic illustration of the gear train but is provided to illustrate the principle of the transmission ratio selection. FIGS. 13 and 11 schematically show a selector 526 including a pivotable plate supporting the variable intermediate gears 520, 522, 524 to pivot a selected one of the variable intermediate gears into engagement with the invariable input gear 516 and the invariable output gear 518 to complete the gear train. Less intermediate gears or additional intermediate gears or other transmission elements may be provided. Instead of a gear train having a variable transmission ratio, a fixed ratio transmission can be provided, as in the example of FIG. 2 to 5. The gears may be toothed gears or friction gears or may be replaced or supplemented by other transmission elements.

Drive roller 508 may be engaged with one of the transport rollers of the media advance system 40, such as driven output roller 408. When the drive roller 508 is engaged with the output roller 408 and when the media advance system 40 drives the medium 400 in the media advance direction Y or in the opposite direction, drive roller 508 revolves on output roller 408 and rotation of the drive roller 508 is transmitted to the rotary cutting blade 506 via the transmission 510 to cut a medium between the rotary cutting blade 506 and a linear cutting blade or counter surface not illustrated in FIGS. 13 and 14. A linear cutting blade or counter surface extending in the media advance direction Y may be provided below the media transport plane, opposite to the rotary cutting blade 506. One or several linear cutting blades or counter surfaces may be provided at the predetermined cutting positions in the scanning direction X or a linear cutting blade or counter surface may be arranged on a transport mechanism to be translated in the scanning direction X so that the linear cutting blade or counter surface can be located opposite to the rotary cutting blade 506. In another example, the passive cutter module may comprise a rotary cutting blade, a linear cutting blade or a counter surface which is arranged in the passive cutter module below the print zone, with a contact-free coupling device, e.g. comprising controllable magnets, in the active cutter module and the passive cutter module, to engage the rotary cutting blade of the active and cutting blade or cutting surface of the passive cutter module wherein, when engaged, the passive cutter module follows movement of the active cutter module and, when disengaged, the passive cutter module remains at a given position irrespective of a movement of the active cutter module.

The active cutter module 50 of this example may be translated to its cutting position, shown in FIGS. 13 and 14, by an electromotive or electromagnetic or another type of actuator 520, for example. The actuator 520 may lower and raise and/or pivoted the support frame 502 of the active cutter module to engage and disengage the drive roller 508 and the output roller 408 which, in this example, is the drive component.

In the various examples, the cutter assembly has a rotary cutting blade, which is driven without a separate drive motor or another dedicated active actuator or impelling mechanism. In various examples, the rotary cutting blade is driven by the carriage movement or by rotation of a media transport roller. The cutter assembly can be associated with a printer carriage to cut in either the X direction or the Y direction. The cutter assembly comprises an active cutter module attached to the printer carriage, the active cutter module including the rotary cutting blade, a drive gear or roller and a gear train (transmission) transmitting rotation of the drive gear or roller to the rotary cutting blade. The cutter assembly further comprises a passive cutter module including a linear cutting blade or a counter surface or a further rotary cutting blade. The cutter assembly further comprises a drive component which, in one variant, includes a linear rack which can be engaged with the drive gear. In another variant, the drive component includes a drive roller which may be a media transport roller of a media transport system. The drive component can be raised or lowered and/or the active cutter module can be raised or lowered or pivoted, to engage the drive gear with the drive rack or to engage the drive roller with the media transport roller so that, when the active cutter module is moved relative to the passive cutter module by movement of the carriage (for cutting in X direction) or when the drive roller is engaged with the media transport roller (for cutting in Y direction), the drive gear or roller rotates and transmits rotation to the rotary cutting blade.

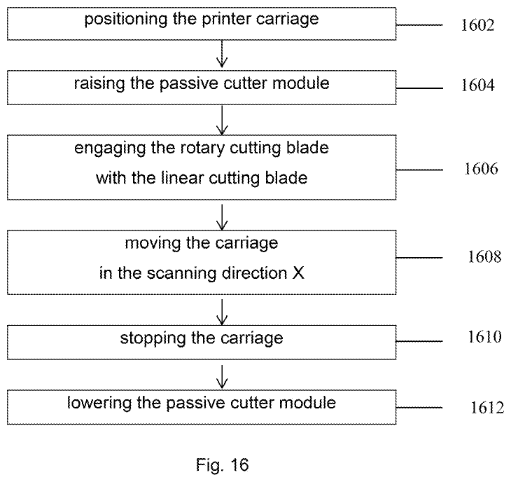

With respect to the examples shown in FIG. 2 to 8, a cutting sequence for cutting in the scanning direction X according to an example is illustrated in FIG. 16 and may comprise: positioning 1602 he printer carriage 10 at a longitudinal side of a medium to be cut or another point of the medium to be cut, with the passive cutter module 30 lowered and the active cutter module 20 in the standby position; raising 1604 the passive cutter module 30, e.g. by the actuators 306, so that the pusher component 240 contacts the sliding surface of the directing component 308 and the support frame 202 is pivoted so that the active cutter module 20 is transferred to the cutting position; in the cutting position, the rotary cutting blade 206 may engage and overlap with the linear cutting blade 304, 1606, as shown in FIG. 3; then, moving 1608 the carriage 10 in the scanning direction X to cut the medium between the rotary cutting blade 206 and the linear cutting blade 304 in the scanning direction X, wherein the rotary cutting blade 206 is driven by the drive gear 208 revolving on the linear rack (drive component) 302 and the transmission 210; and, when the cutting operation is completed, stopping 1610 the carriage 10 and lowering 1612 the passive cutter module 30, e.g. by the actuators 306, so that the pusher component 240 disengages from the sliding surface of the directing component 308 and the support frame 202 is pivoted back, e.g. by a biasing force provided by a spring (not shown), so that the active cutter module 20 is transferred back to the standby position.

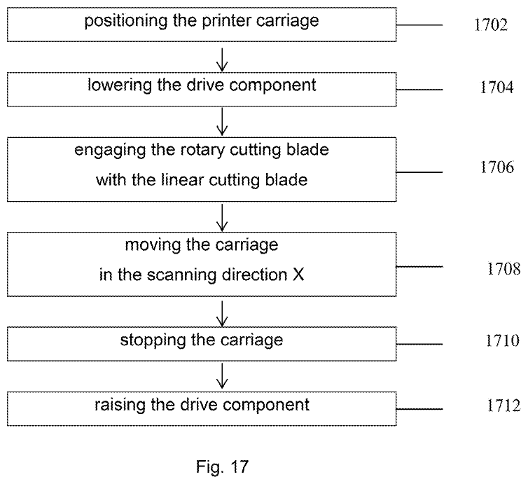

With respect to the example shown in FIG. 9 to 11, a cutting sequence for cutting in the scanning direction X according to an example is shown in FIG. 17 and may comprise: positioning 1702 the printer carriage 10 at a longitudinal side of a medium to be cut or another point of the medium to be cut, with the drive component including the linear rack 310 lifted up and the active cutter module 20 in the standby position; lowering 1704 the drive component including the linear rack 310, e.g. by the actuators 314, so that the pusher component 240 contacts the sliding surface of the directing component 312 and the support frame 202 is pivoted so that the active cutter module 20 is transferred to the cutting position; in the cutting position, the rotary cutting blade 206 may engage and overlap with the linear cutting blade 304, 1706, as shown in FIG. 9, wherein the linear cutting blade 304 may be provided at a fixed position below the active cutter module 20 or, alternatively may be raised and lowered between a standby position and a cutting position; then, moving 1708 the carriage 10 in the scanning direction X to cut the medium between the rotary cutting blade 206 and the linear cutting blade 304 in the scanning direction X, wherein the rotary cutting blade 206 is driven by the drive gear 248 revolving on the linear rack 310 and the transmission 250; and, when the cutting operation is completed, stopping 1710 the carriage 10 and raising 1712 the drive component including the linear rack 310, e.g. by the actuators 314, so that the pusher component 240 disengages from the sliding surface of the directing component 312 and the support frame 202 is pivoted back, e.g. by a biasing force provided by a spring (not shown), so that the active cutter module 20 is transferred back to the standby position.

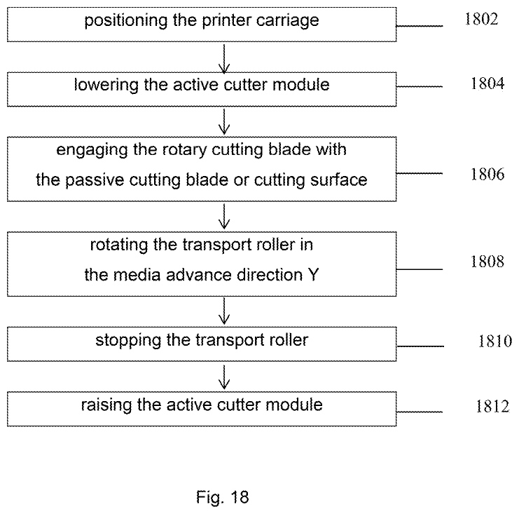

With respect to the example shown in FIGS. 13 and 14, a cutting sequence for cutting in the media advance direction Y according to an example is shown in FIG. 18 and may comprise: positioning 1802 the printer carriage 10 at a point of a medium to be cut, with the active cutter module 50 lifted up and in the standby position; at this point in the sequence, a cutting blade or counter surface may be located opposite the rotary cutting blade 406 of the active cutter module 50, below a media plane; lowering 1804 the active cutter module 50, e.g. by the actuators 520, so that the drive roller 508 contacts the transport roller 408 and the active cutter module 50 is transferred to the cutting position; in the cutting position, the rotary cutting blade 506 may engage and overlap with the passive cutting blade or engage a cutting surface, 1806; then, rotating 1808 the transport roller 408 in the media advance direction Y or in the opposite direction to cut the medium between the rotary cutting blade 506 and the passive cutting blade or surface in the media advance direction Y, wherein the rotary cutting blade 506 is driven by the drive roller 508 revolving on the transport roller 408 (drive component) and the transmission 510; and, when the cutting operation is completed, stopping 1810 the transport roller 408 and raising 1812 the active cutter module 50, e.g. by the actuators 520, so that the rotary cutting blade 506 disengages from the passive cutting blade or surface and the active cutter module 50 is transferred back to the standby position.

When the cutter assembly is provided in a printer, and the active cutter module is supported by a printer carriage, the cutting operation and the printing operation may be performed alternatively and, under certain circumstances, may be performed simultaneously. For example, a leading edge or a trailing edge of the medium may be cut in the scanning direction X simultaneously with printing a start or end of a plot at the said edge.

FIG. 15A shows a top view of a medium 400 which has been cut in the scanning direction X, generating a number of linear intermittent cutting lines 402. Such lines 402 can be used, for example, to provide easily foldable regions or tear off regions in a printed plot. Such intermediate cutting lines can be created by repeatedly activating and deactivating the actuators 306 to engage and disengage the drive component, such as the linear rack 302, 310, and the drive gear 208, 248 and move the active cutter module 20 between the cutting position and the standby position, and, at the same time, scanning the printer carriage 10 in the scanning direction X. Scanning of the printer carriage 10 allows the drive gear 208, 248 to revolve on the linear rack 302, 310 to drive the rotary cutting blade 306. Similar intermittent cutting lines can be created in the media advance direction Y by repeatedly activating and deactivating the actuators 520 to engage and disengage the drive component, such as the media transport roller 408, and the drive roller 508 and move the active cutter module between the cutting position and the standby position and, at the same time, rotating the media transport roller 408. Rotation of the media transport roller 408 drives the drive roller 508 which in turn drives the rotary cutting blade 506 via transmission 512.

FIG. 15B shows a top view of the medium 400 which has been cut in the scanning direction X and in the media advance direction Y, generating a number of linear intermittent and continuous cutting lines and shapes 404. These cutting lines and shapes can be obtained by providing an X cutter assembly, i. e. a cutter assembly aligned and cutting in the scan direction X, as shown in FIG. 1 to 11, and a Y cutter assembly, i. e. a cutter assembly aligned and cutting in the media advance direction Y, as shown in FIGS. 13 and 14, for example.

In a printer, either one of or both of an X cutter assembly and a Y cutter assembly may be provided. If both X and Y cutter assemblies are provided, the X cutter assembly can be arranged at a front or back face of the carriage and the X cutter assembly can be arranged at one of the side faces of the carriage, as show in FIGS. 10 and 13.

Drive of the carriage 10, the media advance system 40 and the actuator(s) may be controlled by a controller (not shown). The controller can be a microcontroller, ASIC, or other control device, including control devices operating based on software or firmware, including machine readable instructions, hardware, or a combination thereof. It can include an integrated memory or communicate with an external memory or both. The same controller or separate controllers may be provided for controlling carriage movement, medium advance and the rotary actuator. Different parts of the controller may be located internally or externally to a printer or separate cutting device, in a concentrated or distributed environment.

In the example illustrated, the cutter assembly has been described to be part of a printer and the active cutter module of the cutter assembly has been described to be attached to a printer carriage 10. In a variant, the cutter assembly can be provided at its own dedicated carriage and/or it can be provided as a stand-alone device or in combination with other types of equipment.

1. A cutter assembly for a printer, the cutter assembly including
an active cutter module to be arranged at a printer carriage, the active cutter module including a movable cutting blade and a transmission,
a passive cutter module to be arranged opposite the active cutter module, with a print media path located between the active cutter module and the passive cutter module; and
a drive component to be engaged and disengaged with the transmission.

2. The cutter assembly of claim 1 wherein the drive component comprises a linear rack extending in a printer carriage scanning direction and movable to be engaged and disengaged with the transmission.

3. The cutter assembly of claim 2 wherein the linear rack is arranged at the passive cutter module below the print media path and is raised to be engaged with the transmission.

4. The cutter assembly of claim 2 wherein the linear rack is arranged above the active cutter module and is lowered to be engaged with the transmission.

5. The cutter assembly of claim 2 wherein the linear rack is provided with a directing component and the active cutter module is provided with a pusher component, wherein, when the linear rack is moved to be engaged with the transmission, the pusher component is engaged with the direction component to transfer the active cutter module into a cutting position.

6. The cutter assembly of claim 5 wherein the directing component comprises a sliding surface extending parallel to the linear rack and engagement of the pusher component with the sliding surface pivots the active cutter module to the cutting position.

7. The cutter assembly of claim 2 further including an electromotive or electromagnetic actuator to raise and lower the linear rack.

8. The cutter assembly of claim 1 wherein the transmission comprises a drive roller and the drive component comprises a media transport roller, the drive roller to be engaged with the media transport roller.

9. The cutter assembly of claim 8 wherein the active cutter module is movable to engage and disengage the drive roller and the media transport roller.

10. The cutter assembly of claim 1 wherein the transmission comprises a gear train having an adjustable transmission ratio, interposed between the drive component and the movable cutting blade, to select a rotation speed of the rotary cutting blade.

11. The cutter assembly of claim 1 wherein the moveable cutting blade is a rotary cutting blade which is driven by the transmission.

12. The cutter assembly of claim 3 wherein the passive cutter module includes a static linear cutting blade or cutting surface arranged at and parallel to the linear rack.

13. A printer, including:
a platen to support a print medium in a print zone;
a print medium advance system to transport the print medium through the print zone in a media advance direction;
a carriage to receive a print head, the carriage moving across the print zone in a scanning direction, the scanning direction perpendicular to the media advance direction;
an active cutter module arranged at the carriage above the print zone, the active cutter module including a rotary cutting blade and a transmission, the transmission comprising a drive gear,
a passive cutter module arranged opposite the active cutter module and below the print zone; and
a linear rack extending across the print zone in the scanning direction and movable to be engaged and disengaged with the drive gear wherein,
when the linear rack and the drive gear are engaged and the carriage moves in the scanning direction, the drive gear revolves on the linear rack and rotation of the drive gear drives the rotary cutting blade via the transmission.

14. The printer of claim 13, wherein the linear rack is provided with a sliding surface and the active cutter module is provided with a pusher component and, when the linear rack is moved to be engaged with the drive gear, the pusher component contacts the sliding surface and the active cutter module is pivoted to a cutting position.

15. A printer, including:
a platen to support a print medium in a print zone;
a print medium advance system to transport the print medium through the print zone in a media advance direction, the print media advance system comprising a media transport roller;
a carriage to receive a print head;
an active cutter module arranged at the carriage above the print zone, the active cutter module including a rotary cutting blade and a transmission, the transmission comprising a drive roller,
a passive cutter module arranged opposite the active cutter module and below the print zone;
wherein the active cutter module is movable to engage and disengage the drive roller and the media transport roller wherein,
when the drive roller and the media transport roller are engaged and the print medium advance system transports the print medium in the media advance direction, the drive roller is driven by the media transport roller and rotation of the drive roller drives the rotary cutting blade via the transmission.
